(19) United States
(12) Patent Application Publication
(10) Pub. No.: US 2015/0368933 A1
(43) Pub. Date: Dec. 24, 2015

(54) MECHANICALLY INITIATED SPEED-BASED LATCH DEVICE

(71) Applicant: Ford Global Technologies, LLC, Dearborn, MI (US)

(72) Inventors: Kosta Papanikolaou, Huntington Woods, MI (US); Rajesh K. Patel, Farmington Hills, MI (US); David Manuel Rogers, Southfield, MI (US); Livianu Dorin Puscas, Rochester Hills, MI (US)

(21) Appl. No.: 14/755,144

(22) Filed: Jun. 30, 2015

Related U.S. Application Data
(62) Division of application No. 13/644,520, filed on Oct. 4, 2012, now Pat. No. 9,115,514.

(51) Int. Cl. E05B 77/06; E05B 79/22

(52) U.S. Cl. CPC E05B 77/06; E05B 79/22

(57) ABSTRACT

A pawl actuation device includes a movable input member that shifts from a first position to an actuated position. The pawl actuation device also includes linkage that selectively interconnects the movable input member and the pawl such that movement of the movable input member at a first velocity causes the pawl to shift to an unlatched position, and movement of the movable input member at a second velocity that is substantially greater than the first velocity does not cause the pawl to shift to its unlatched position, such that pawl remains in its latched position.

### CROSS-REFERENCE TO RELATED APPLICATION

This present application is a divisional of U.S. patent application Ser. No. 13/644,520 filed on Oct. 4, 2012, entitled “MECHANICALLY INITIATED SPEED-BASED LATCH DEVICE,” the entire contents of which are incorporated by reference.

### FIELD OF THE INVENTION

The present invention generally relates to a door latch system for motor vehicles, and specifically to a door latch that does not release unless the handle is pulled open slowly.

### BACKGROUND OF THE INVENTION

Various types of vehicle door latches and handles have been developed. The latch and handle assembly may include a handle that can be pulled outwardly by a user to release a door latch, thereby permitting the door to open. However, if a vehicle is subject to a lateral acceleration, the acceleration may cause the handle to shift outwardly due to its own mass, thereby causing the latch to release. Various counterweights and inertia locks have been developed to prevent inadvertent unlatching of a door latch during lateral acceleration of the vehicle.

With reference to FIGS. 1 and 2, a prior art latch release mechanism 5 includes an outside release lever 6 having an end 8 that is operably connected to an outside door handle (not shown) of a motor vehicle. An intermediate link 10 is pivotably connected to outside release lever 6 at a pin or pivot 12, such that rotation of outside release lever 6 from a rest position to an actuated position causes link 10 to shift longitudinally as indicated by the arrow “A.” End 14 of link 10 includes a step or notch 16 having a push surface 18 that is configured to engage a surface 20 of a pawl lifter 22. Pawl lifter 22 is rotatably connected to a door structure by a rotatable connector 24 which may comprise a boss, pin, shaft, or the like for movement. Link 10 is rotatably biased into engagement with pawl lifter 22 by a torsion spring (not shown) at pivot 12. The torsion spring biases link 10 in a counter clockwise direction (FIGS. 1 and 2), such that longitudinally extending surface 26 of link 10 slidably engages end surface 28 of pawl lifter 22 as link 10 moves in the direction of the arrow “A.” Thus, when assembled and in operation, surface 26 of link 10 always remains engaged with end surface 28 of pawl lifter 22, regardless of the position and velocity of link 10. It will be understood that, in FIG. 1, link 10 is shown in a rotated position solely to show surface 26. When latch release mechanism 5 is assembled, surface 26 of link 10 always contacts/engages surface 28 of pawl lifter 22 as shown in FIG. 2 due to rotational bias (torsion spring) acting at pivot 12.

If an exterior force tending to rotate outside release lever 6 in the direction of the arrow A1 is applied to an outside door handle, link 10 shifts longitudinally in the direction of the arrow A with surfaces 26 and 28 slidably engaging each other initially. Surfaces 18 and 20 come into contact and abuttingly engage one another to thereby rotate pawl lifter 22 in the direction of the arrow “A2” from its unlatched position to its latched position. Thus, in operation, movement of outside release lever 6 from its rest position to its actuated position always causes surface 18 of link 10 to contact surface 20 of pawl lifter 22 and always rotates pawl lifter 22 from its unlatched position to its latched position and always unlatches the vehicle door latch, regardless of the velocity at which outside release lever 6 is moved from its rest position to its actuated position. Thus, the prior art latch mechanism 5 is not capable of providing velocity-based release, and the prior art linkage is not capable of selectively interconnecting a movable input member (e.g. outside release lever 6) and a movable pawl member (e.g. pawl lifter 32) such that movement of the movable input member at a first velocity causes the movable pawl to shift to an unlatched position, and movement of the movable input member at a second velocity that is substantially greater than the first velocity does not cause the movable pawl to shift to its unlatched position, such that the movable pawl member remains in its latched position. The pawl (not shown) is directly connected to pawl lifter 22, such that rotation of pawl lifter 22 from its unlocked position to its locked position causes the pawl to shift from the latched position to the unlatched position, thereby unlatching the vehicle door latch.

### SUMMARY OF THE INVENTION

One aspect of the present invention is a vehicle door including a device for controlling actuation of a pawl of a vehicle door latch mechanism based on a rate of movement of an exterior vehicle door handle. The vehicle door includes a door structure, and an outside door handle movably mounted to the door structure. The door also includes an outside release member that is movably mounted to the door structure. The outside release member is operably connected to the outside door handle such that movement of the outside door handle causes movement of the outside release lever from a first position to an actuated position. The vehicle door further includes a latch mechanism mounted to the door structure. The latch mechanism includes a movable latch member and a movable pawl. The movable pawl selectively retains the latch member in a latched position when the pawl is in a latched position, and permits movement of the latch when the pawl is in a unlatched position. The vehicle door still further includes an intermediate link that selectively interconnects the outside release member to the pawl lifter when the intermediate link is in an engaged configuration. The intermediate link is biased from a first disengaged configuration towards the engaged configuration. The intermediate link further defines a second disengaged position, and the intermediate link includes a first pawl-engaging surface. The movable pawl has a first link-engaging surface that engages the first pawl-engaging surface of the intermediate link when the intermediate link is in the engaged configuration to thereby cause movement of the pawl from its latched position to its unlatched position upon movement of the outside release member from its first position to its actuated position. The intermediate link includes a second pawl-engaging surface and the movable pawl has a second link-engaging surface that selectively engages a second pawl-engaging surface to retain the link in a disengaged configuration when the outside release member is in the first position. Shifting of the outside release member from the first position to the actuated position at a first velocity causes the link to shift to engaged configuration and engage the pawl and move the pawl from its latched position to its unlatched position. Shifting of the outside release member from the first position to the actuated position at a second velocity causes the link to shift from its first disengaged position to its second disengaged position without moving the pawl to its unlatched position if the second velocity is significantly greater than the first velocity.

Another aspect of the present invention is a pawl actuation device including a pawl selectively locking a door latch in an engaged position when the pawl is in a latched position. The device further includes a movable input member that shifts from a first position to an actuated position. The pawl actuation device also includes linkage that selectively interconnects the movable input member and the pawl such that movement of the movable input member at a first velocity causes the pawl to shift to an latched position, and movement of the movable input member at a second velocity that is substantially greater than the first velocity does not cause the pawl to shift to its unlatched position such that pawl remains in its latched position.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is an isometric view of a prior art door latch release assembly;

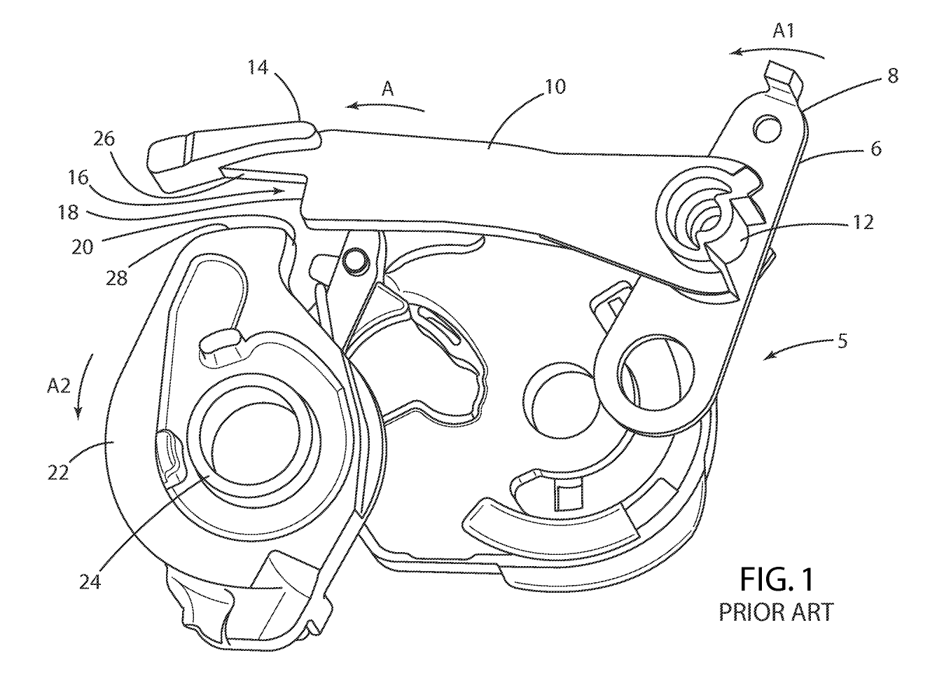

FIG. 2 is a schematic view of the prior art door latch release assembly of FIG. 1;

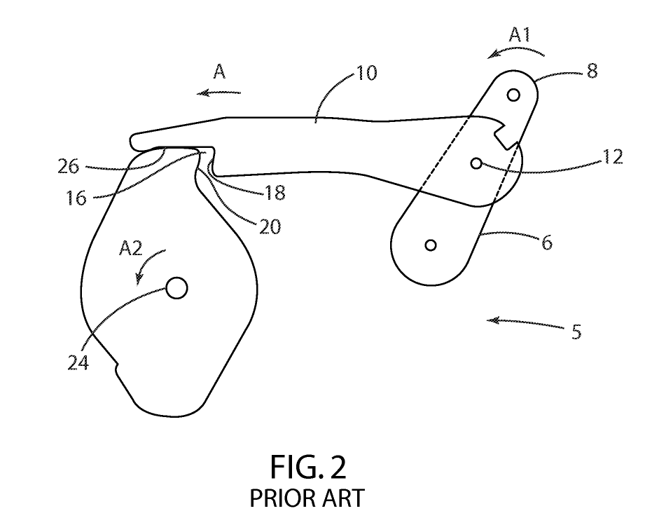

FIG. 3 is a partially schematic view of a latch device according to one aspect of the present invention wherein the door handle is in a closed position;

FIG. 4 is a partially schematic view of a latch device according to one aspect of the present invention wherein the linkage is engaged as a result of a relatively slow outward pull of the handle;

FIG. 5 is a partially schematic view of the latch device of FIG. 4 showing the link being reset to the configuration of FIG. 3 after release of a door handle; and

FIG. 6 is a partially schematic view of the linkage device showing the link shifted to a disengaged position due to relatively rapid opening of the door handle.

### DETAILED DESCRIPTION OF THE PREFERRED EMBODIMENTS

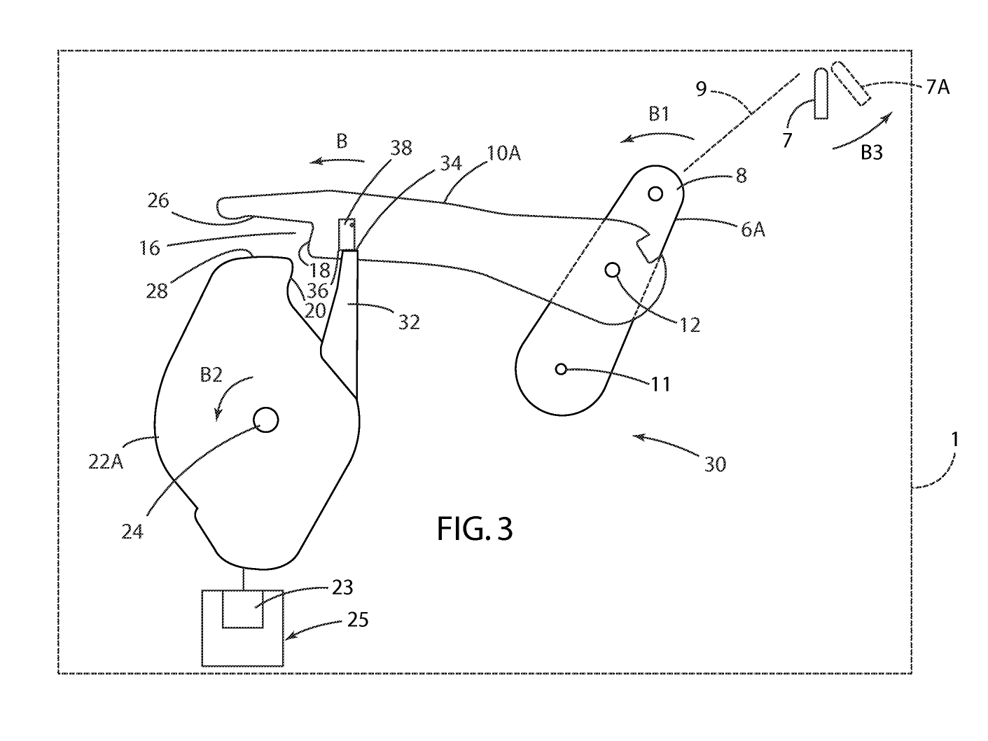

For purposes of description herein, the terms “upper,” “lower,” “right,” “left,” “rear,” “front,” “vertical,” “horizontal,” and derivatives thereof shall relate to the invention as oriented in FIG. 3. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

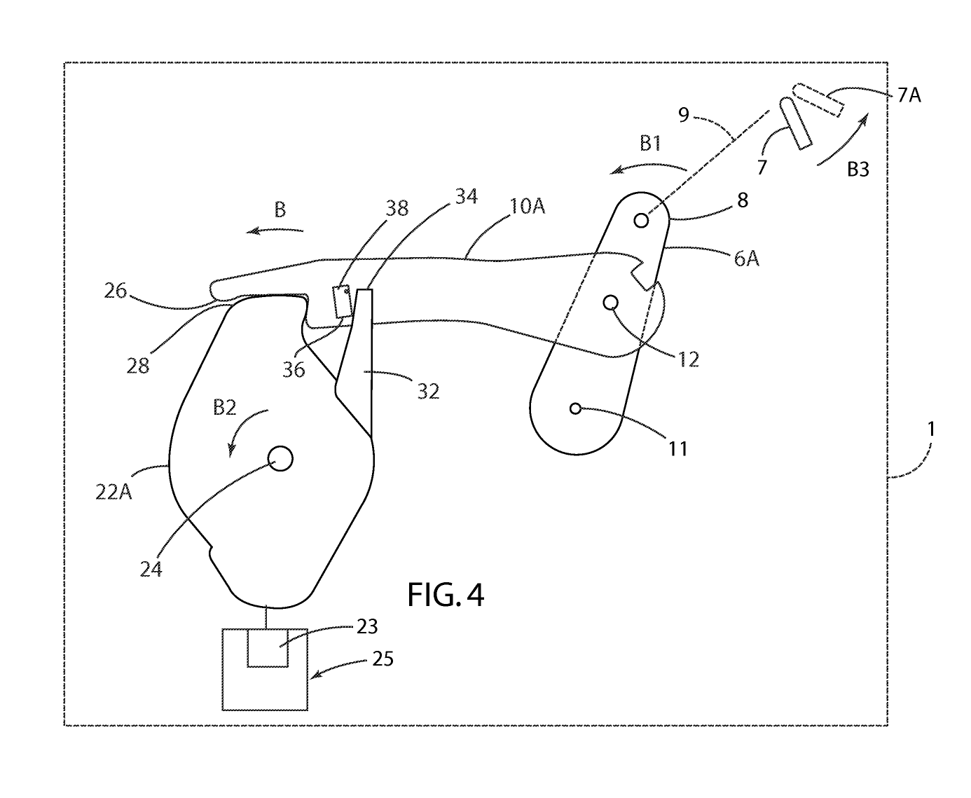

With reference to FIG. 3, a latch mechanism 30 according to one aspect of the present invention includes an outside release member such as release lever 6A that is operably connected to an outside door handle 7 by a known linkage 9. Movement of handle 7 causes outside release lever 6A to rotate about pin or pivot 11. Latch mechanism 30 also includes a link 10A, and a pawl lifter 22A that is operably connected to a pawl 23 of a conventional latch mechanism 25. Outside release lever 6A is rotatably connected to a door structure 1 by pin or pivot 11. Link 10A includes a step 16 defined by transverse surfaces 18 and 26. Pawl lifter 22A includes surfaces 20 and 28 that engage surfaces 18 and 26, respectively, of link 10A. Pawl lifter 22A includes a prong or extension 32 having an end surface 34. (See also FIG. 4). Link 10A includes a block or extension 38 defining a surface 36 that engages end surface 34 of prong 32 of pawl lifter 22A when the mechanism 30 is in the configuration of FIG. 3. FIG. 3 shows a configuration in which the door is closed and latched, and the outside door handle is in a non-actuated or rest position.

If the outside door handle 7 is pulled open slowly in the direction of arrow B3 towards the position 7A, link 10A shifts in the direction of the arrow B (FIG. 4), and surface 36 of link 10A slides along surface 34 of prong 32 of pawl lifter 22A until the surfaces 36 and 34 disengage from one another, resulting in counterclockwise rotation of link 10A. Once the surfaces 34 and 36 disengage, the counterclockwise bias acting on link 10A initially causes link 10A to rotate, bringing surfaces 26 and 28 of link 10A and pawl lifter 22A, respectively, into contact with one another. As handle 7 and outside release lever 6A are further rotated, link 10A shifts longitudinally in the direction of the arrow B. Surfaces 18 and 20 of link 10A and pawl lifter 22A, respectively, then come into contact/engagement with each other. Further rotation of handle 7 and outside release lever 6A further shifts the link 10A in the direction of the arrow B, thereby rotating pawl lifter 22A in the direction of the arrow B2. Rotation of pawl lifter 22A releases the pawl 23 of the latch mechanism 25, thereby unlatching the latch mechanism 25 and permitting the vehicle door to open.

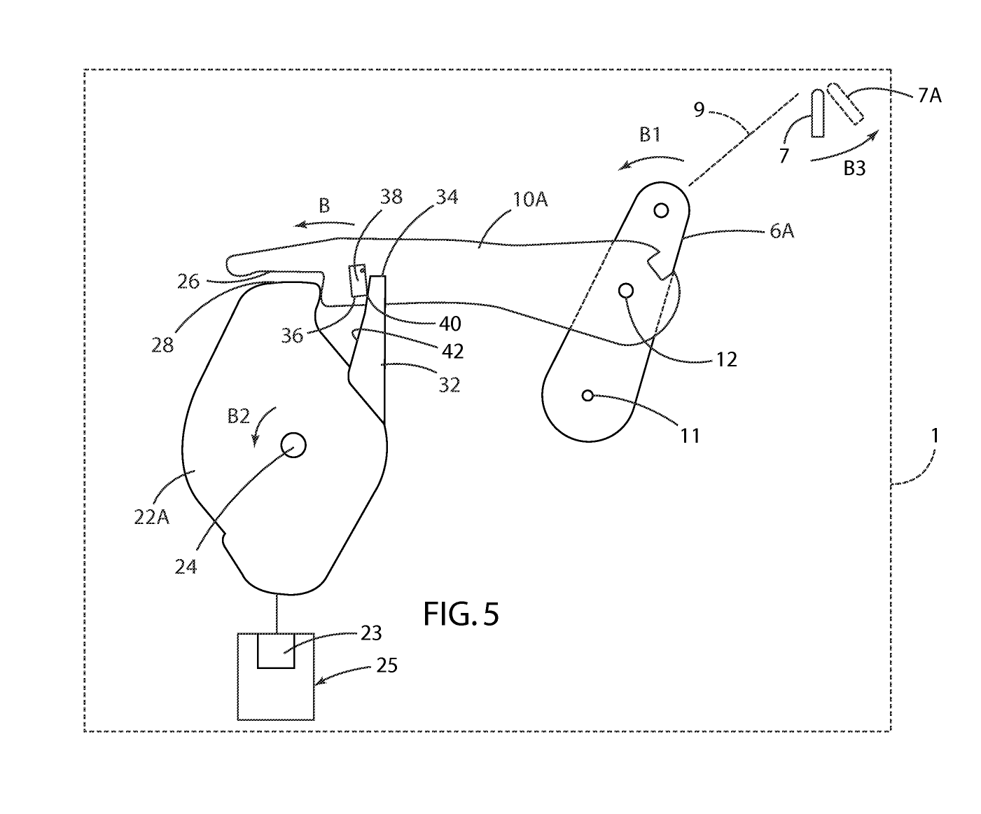

With further reference to FIG. 5, a spring of a known type (not shown) biases lever 6A and handle 7 in directions opposite arrows B1 and B3, respectively. Thus, after a user releases the handle 7 the handle 7 rotates in a direction that is opposite arrow B3, and lever 6A rotates in the direction opposite the arrow B1. Rotation of lever 6A causes link 10A to shift in a direction opposite the arrow B. As the link 10A shifts in a direction opposite the arrow B, a corner surface 40 of block 38 of link 10A slides along surface 42 of prong 32 of pawl lifter 22A, and surfaces 26 and 28 of link 10A and pawl lifter 22A, respectively, disengage from one another. As the link 10A continues to shift in a direction opposite the arrow “B”, the link 10A and pawl lifter 22A rotate in a clockwise direction, and return to the configuration shown in FIG. 3, thereby resetting the latch mechanism 30 to its initial or rest position.

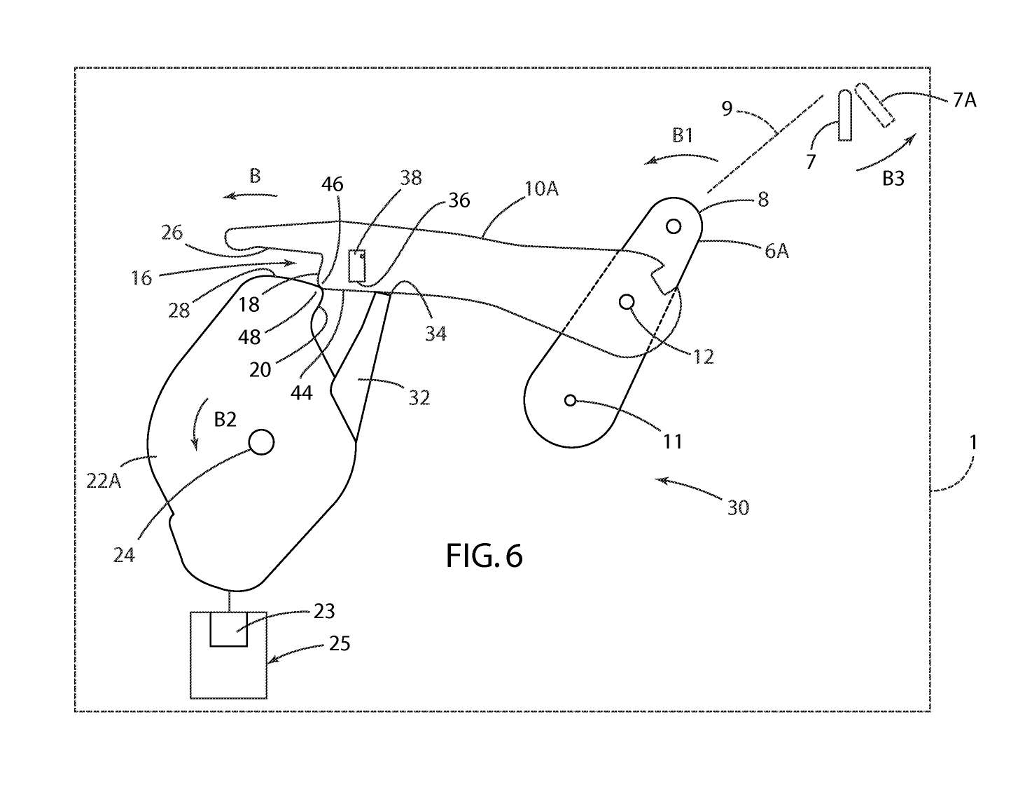

In the event the latch mechanism 30 is in the rest or initial position of FIG. 3, and if outside release lever 6A is rotated in the direction of the arrow B1 at a relatively high velocity, the link 10A will shift in the direction of the arrow B as shown in FIG. 6, and surface 44 of link 10A will slidably engage end surface 28 of pawl lifter 22A as shown in FIG. 6. High velocity rotation of release lever 6A causes outside corner 46 of link 10A to slide past outside corner 48 of pawl lifter 22A, resulting in sliding engagement between surface 44 of link 10A and end surface 28 of pawl lifter 22A. However, this sliding engagement does not generate sufficient force to rotate pawl lifter 22A in the direction of the arrow B2. As discussed above, link 10A is rotatably biased in a counterclockwise direction (FIG. 6). However, if the link 10A is shifted in the direction of the arrow B quickly enough, the link 10A will not rotate to the engaged position of FIG. 4, but rather will shift to the disengaged configuration of FIG. 6. Because push surface 18 of link 10A does not engage surface 20 of pawl lifter 22A when the latch mechanism 30 is in a configuration of FIG. 6, further rotation of outside release lever 6A due to outward movement of the vehicle door handle will not result in rotation of pawl lifter 22A. Pawl lifter 22A may be rotationally biased in a direction opposite arrow B2 to prevent movement of pawl lifter 22A due to sliding contact between surfaces 26 and 28 of link 10A and pawl lifter 22A, respectively.

It has been found that a user will typically move a door handle (e.g. handle 7) at 300 mm/s or less when opening a vehicle door. However, the handle 7 will typically move at 2500 mm/s or more in the event a vehicle is subject to a side impact event. Accordingly, in the illustrated example, the latch mechanism 30 is configured such that movement of the handle at 300 mm/s or less will result in the link 10A shifting to the engaged position of FIG. 4, thereby resulting in rotation of pawl lifter 22A and movement of the pawl to an unlatched position. However, if the outside handle is moved at 2500 mm/s or more, the outside corner 46 of link 10A slides past outside corner 48 pawl lifter 22A as shown in FIG. 6, such that pawl lifter 22A does not rotate, and the pawl of the door latch is not shifted to an unlatched position.

It is to be understood that variations and modifications can be made on the aforementioned structure without departing from the concepts of the present invention, and further it is to be understood that such concepts are intended to be covered by the following claims unless these claims by their language expressly state otherwise.

We claim:

1. A velocity-based latch release device, comprising:
a door latch having latched and unlatched configurations;
a movable input member that shifts from a first position to an actuated position; and
linkage selectively interconnecting the movable input member and the door latch, wherein the linkage is configured such that movement of the movable input member at a first velocity always causes the latch to unlatch, and movement of the movable input member at a second velocity that is substantially greater than the first velocity does not cause the door latch to unlatch such that the door latch remains in its latched configuration.

2. The velocity-based latch release device of claim 1, wherein:
the movable input member comprises a rotatable lever, and the linkage includes a link member pivotably connected to the rotatable lever for movement between engaged and disengaged configurations.

3. The velocity-based latch release device of claim 2, wherein:
the door latch includes a movable pawl member, and the link member contacts the movable pawl in a manner that retains the link member in a disengaged configuration when the movable input member is in its first position.

4. The velocity-based latch release device of claim 3, wherein:
the link member is rotatably biased towards the engaged configuration.

5. The velocity-based latch release device of claim 4, including:
a mounting structure; and wherein:
the rotatable lever is rotatably connected to the mounting structure;
the link member has a first end that is rotatably connected to the rotatable lever, the link having a second end adjacent the movable pawl, the second end having a stepped surface comprising first and second engagement surfaces facing towards the movable pawl, and a pawl-engaging surface extending transversely between the first and second engagement surfaces to define inner and outer corners, the link further including a third pawl-engaging surface that faces the movable pawl;
the movable pawl is rotatably connected to the mounting structure and includes first and second adjacent transverse link-engaging surfaces forming an outwardly projecting corner that selectively engages the inner corner of the link member when the link member is in the engaged configuration such that movement of the link member causes the movable pawl to rotate, and wherein the link member slidably engages the first link-engaging surface when the link member is in a disengaged configuration; and wherein:
the movable pawl includes a prong structure extending adjacent to the outwardly projecting corner, the prong structure having an end surface that contacts the third pawl-engaging surface of the link member to selectively retain the link member in the disengaged configuration.

6. A velocity-based latch release, comprising:
a pawl; and
a linkage configured to engage the pawl and shift the pawl from a latched position to an unlatched position if an input point on the linkage moves at a first velocity, and wherein the linkage does not unlatch the pawl if the input point moves at a second velocity that is significantly greater than the first velocity.

7. The latch release of claim 6, wherein:
the linkage includes a link member that shifts between engaged and disengaged configurations, and wherein the link member is biased towards the engaged configuration.

8. The latch release of claim 7, including:
a support structure; and wherein:
the pawl is pivotably connected to the support structure, and
the linkage includes a release member pivotably connected to the support structure.

9. The latch release of claim 7, wherein:
the pawl engages the link member and retains the link member in the disengaged configuration.

10. A vehicle door including the velocity-based latch release of claim 1, wherein:
the vehicle door includes a door structure and an outside door handle that is movably mounted to the door structure;
the vehicle door includes a latch mechanism including a movable latch member and the movable pawl, wherein the movable pawl selectively retains the latch member in a latched position when the pawl is in a latched position and permits movement of the latch from a latched position to an unlatched position when the movable pawl is in an unlatched position;
the movable input member comprises an outside release member that is movably mounted to the door structure, and wherein the outside release member is operably connected to the outside door handle such that movement of the outside door handle causes movement of the outside release member from a first position to an actuated position;
the linkage comprises an intermediate link that selectively interconnects the outside release member to the movable pawl when the intermediate link is in an engaged configuration, wherein the intermediate link is biased from a first disengaged configuration towards the engaged configuration, the intermediate link further defining a second disengaged configuration, the intermediate link including a first pawl-engaging surface;
the movable pawl having a first link-engaging surface that engages the first pawl-engaging surface of the intermediate link when the intermediate link is in the engaged configuration to thereby cause movement of the movable pawl from its locked position to its unlocked position upon movement of the outside release member from its first position to its actuated position;
wherein the intermediate link includes a second pawl-engaging surface and the movable pawl has a second link-engaging surface that selectively engages the second pawl-engaging surface to retain the link in a disengaged configuration when the outside release member is in the first position;
and wherein shifting of the outside release member from the first position to the actuated position at a first velocity causes the link to shift to its engaged configuration and engage the movable pawl and move the movable pawl from its locked position to its unlocked position, and wherein shifting of the outside release member from the first position to the actuated position at a second velocity that is significantly greater than the first velocity causes the link to shift from its first disengaged position to its second disengaged position without moving the movable pawl to its unlocked position.

11. A vehicle door including the velocity-based latch release of claim 6, wherein:
the vehicle door includes a door structure and an outside door handle that is movably mounted to the door structure;
the vehicle door includes an outside release member movably mounted to the door structure, the outside release member being operably connected to the outside door handle such that movement of the outside door handle causes movement of the outside release member from a first position to an actuated position;
the vehicle door includes a latch mechanism mounted to the door structure, the latch mechanism including a movable latch member and the pawl wherein the pawl selectively retains the latch member in a latched position when the pawl is in a latched position and permits movement of the latch from a latched position to an unlatched position when the pawl is in an unlatched position;
the linkage comprises an intermediate link that selectively interconnects the outside release member to the pawl when the intermediate link is in an engaged configuration, wherein the intermediate link is biased from a first disengaged configuration towards the engaged configuration, the intermediate link further defining a second disengaged configuration, the intermediate link including a first pawl-engaging surface;
the pawl having a first link-engaging surface that engages the first pawl-engaging surface of the intermediate link when the intermediate link is in the engaged configuration to thereby cause movement of the pawl from its locked position to its unlocked position upon movement of the outside release member from its first position to its actuated position;
wherein the intermediate link includes a second pawl-engaging surface and the pawl has a second link-engaging surface that selectively engages the second pawl-engaging surface to retain the link in a disengaged configuration when the outside release member is in the first position;
and wherein shifting of the outside release member from the first position to the actuated position at a first velocity causes the link to shift to its engaged configuration and engage the pawl and move the pawl from its locked position to its unlocked position, and wherein shifting of the outside release member from the first position to the actuated position at a second velocity that is significantly greater than the first velocity causes the link to shift from its first disengaged position to its second disengaged position without moving the pawl to its unlocked position.

12. A velocity-based latch release device, comprising:
a door latch having latched and unlatched configurations;
a movable input member that shifts from a first position to an actuated position;
linkage configured to interconnect the movable input member and the door latch such that movement of the movable input member from the first position to the actuated position causes the latch to unlatch only if the movable input member moves at a speed that is less than a predefined allowable speed.

13. The velocity-based latch release device of claim 12, wherein:
the predefined allowable speed is 300 mm/s.

14. The velocity-based latch release device of claim 12, wherein:
the linkage is configured to disconnect the movable input member and the door latch only if the movable input member is moved from the first position to the actuated position at a speed that is greater than a predefined non-release speed.

15. The velocity-based latch release device of claim 14, wherein:
the non-release speed is 2500 mm/s.
